(19) United States
(12) Patent Application Publication
(10) Pub. No.: US 2021/0140570 A1
(43) Pub. Date: May 13, 2021

(54) OFFSET-ALIGNMENT PIVOTABLE COUPLER FITTINGS FOR SEALABLY INTERCONNECTING HIGH-PRESSURE LINES

(71) Applicant: Gary Arthur STROUD, British Columbia (CA)

(72) Inventor: Gary Arthur STROUD, British Columbia (CA)

(21) Appl. No.: 16/752,938

(22) Filed: Jan. 27, 2020

(30) Foreign Application Priority Data
Nov. 12, 2019 (CA) 3061252

(51) Int. Cl. F16L 27/087; F16L 15/04; F16L 15/00

(52) U.S. Cl. CPC F16L 27/087; F16L 15/003; F16L 15/04

(57) ABSTRACT

An offset-alignment pivotable high-pressure coupler fitting for use to demountably and sealingly engage two misaligned high-pressure fluid lines. The coupler fitting comprises: (i) a female part having a bore therethrough with one end configured for sealing demountable engagement with an end of a first high-pressure fluid line and the other end having a symmetrical spherical recess, (ii) a male part having a bore therethrough with one end configured for sealing demountable engagement with an end of a second high-pressure fluid line and the other end having a symmetrical spherical protrusion that matches and is slidingly communicable with the spherical recess in the female part, and (iii) demountable engagement means configured for demountable and sealing engagement of the symmetrical spherical recess of the female part and the symmetrical spherical protrusion of the male part.

### TECHNICAL FIELD

Various embodiments disclosed herein generally relate to coupler fittings for high-pressure fluid lines. More specifically, this disclosure pertains to offset-alignment pivotable coupler fittings for sealingly interconnecting two misaligned high-pressure fluid lines.

### BACKGROUND

Ultra-high-pressure (UHP) fluid lines are used in many industrial applications for conversion of pressurized kinetic energy into mechanical energy. Examples of fluids that are commonly used for hydraulic power in complex industrial installations under ultra-high pressure include, water, steam, oil, and selected gases. It is common in large industrial installations, for hydraulic fluids to be pressurized by specialized equipment to high pressures or ultra-high pressures, for example in the range of 30,000 psi to 150,000 psi (207 mPa to 1,034 mPa), and then conveyed under high pressure or ultra-high pressure to one or more large-scale pieces of equipment for conversion of its kinetic energy into mechanical energy for industrial processes.

UHP fluids are commonly conveyed throughout such systems within infrastructures of stainless-steel tubing or alternatively, infrastructures of cold-drawn steel tubing. The walls of steel tubing used for conveyance of UHP fluids are very thick, for example an UHP steel tube with a ¼″ (6.35 mm) OD tube may have a 0.094″ (2.39 mm) ID with a pressure rating of 60,000 PSI; an UHP steel tube with a ⅜″ (9.53 mm) OD tube may have a 0.125″ (3.18 mm) ID with a pressure rating of 60,000 PSI; an UHP steel tube with a 9/16″ (7.94 mm) OD tube may have a 0.188″ (4.78 mm) ID with a pressure rating of 60,000 PSI; an UHP steel tube with a 9/16″ (7.94 mm) OD tube may have a 0.250″ (6.35 mm) ID with a pressure rating of 40,000 PSI; ; an UHP steel tube with a 1″ (25.4 mm) OD tube may have a 0.438″ (11.13 mm) ID with a pressure rating of 43,000 PSI, and so on.

Industrial UHP fluid conveyance infrastructures include multiple locations wherein coupler fittings sealingly interconnect two UHP fluid lines, for example, at a juncture with an UHP line egressing from a pump or a boiler wherein a fluid has been pressurized or adjacent to a piece of industrial equipment that is interconnected to the UHP fluid conveyance infrastructure. Commonly used for inline sealingly engaging and coupling together two UHP lines are coupling assemblies. The ends UHP lines are typically flared or alternatively, terminate in coned or and nippled shapes. A terminal end-facing gland nut is slipped over each end of an UHP line that is to be interconnect with another end of an UHP line followed by a collar over each end. Then a coupling body is threaded onto on the end-facing gland nut. An insert is then inserted into the coupling body so that its end abuts and engages the flared end or nippled end of the UHP line. The other UHP line fitted with a terminal end-facing gland nut and collar, is then inserted into the other end of the coupler body and its gland nut is threadably engaged with the coupling body, and finally, the two gland nuts are tightly engaged with the coupling body until the coupling sealably tightened.

There are numerous problems associated with the use of such coupling assemblies for providing durable, long-lasting, and leakproof interconnections between a plurality of two inline UHP lines within a sealed highly pressurized piping infrastructure. Regular maintenance of such complex industrial systems often requires replacement of coupling mixtures conjoining UHP lines. Such types of sealed pressure systems typically contain substantial amounts of stored energy that present significant safety hazards to personnel and equipment it the piping infrastructure, or its isolated substructures, are not properly and fully vented prior to opening high-pressure fittings. Another problem associated with high-pressure fittings is metal fatigue of one or both parts of a coupling fitting that may result from kinetic pressure exerted by the flows of highly pressurized fluids through the highly pressurized piping infrastructures. Yet another problem associated with such high-pressure coupling fittings that it is difficult to sufficiently sealingly tightening a coupling fitting assembly together to maintain a leak-proof seal for extended periods of time, if the two high-pressure lines being joined together are not exactly inline. However, if two high-pressure lines being joined together are misaligned, it is difficult to sealingly engage and tighten their coupling fitting assembly together. Furthermore, the coupling fitting assemblies currently available tend to quickly fail when installed to join together two misaligned high-pressure lines. Another problem commonly encountered in industrial settings having multiple pieces of large processing equipment interconnected into a sealed highly pressurized piping infrastructure, is that replacement parts for a piece of equipment that are interconnectable with one or more UHP lines, may have different shapes and/or dimensions thereby causing one or more misalignments between UHP lines interconnected with the replacement parts and the sealed highly pressurized piping infrastructure. Further adding to this problem is that quite often, replacement pieces of equipment have different sizes and shapes compared to their predecessors, causing additional problems and challenges for sealing engagement of the replacement equipment with and into the sealed highly pressurized piping infrastructure.

### SUMMARY

The embodiments of the present disclosure generally relate to offset-alignment pivotable high-pressure coupler fittings for use to demountably and sealingly engage two misaligned high-pressure fluid lines. The offset-alignment pivotable high-pressure coupler fittings disclosed herein generally comprise (i) a female part having a bore therethrough with one end configured for sealing demountable engagement with an end of a first high-pressure fluid line and the other end having a symmetrical spherical recess, (ii) a male part having a bore therethrough with one end configured for sealing demountable engagement with an end of a second high-pressure fluid line and the other end having a symmetrical spherical protrusion that matches and is slidingly communicable with the spherical recess in the female part, and (iii) demountable engagement means configured for demountable and sealing engagement of the symmetrical spherical recess of the female part and the symmetrical spherical protrusion of the male part.

### BRIEF DESCRIPTION OF THE DRAWINGS

The present invention will be described in conjunction with reference to the following drawings in which:

FIG. 1 illustrates an example of an embodiment of a two-piece offset pivotable high-pressure coupler fitting according to the present disclosure wherein FIG. 1A shows the fitting components engaged in an inline configuration, while FIG. 1B shows the fitting components engaged in an offset configuration;

FIG. 2 shows orthogonal views of the separated female component (FIG. 2A) and male component (FIG. 2B) comprising the two-piece offset pivotable high-pressure coupler fitting shown in FIG. 1;

FIG. 3 shows side views of the separated female component (FIG. 2A) and male component (FIG.2B) comprising the two-piece offset pivotable high-pressure coupler fitting shown in FIGS. 1 and 2;

FIG. 4 is an exploded cross-sectional side view of the two-piece offset pivotable high-pressure coupler fitting configured inline as shown in FIG. 1A;

FIG. 5 is an exploded cross-sectional side view of the two-piece offset pivotable high-pressure coupler fitting from FIG. 1B, shown configured offset from a 180° inline connection;

FIG. 6 is a side view of an example of another embodiment of the present disclosure showing an inline-aligned high-pressure connector assembly comprising the two-piece offset pivotable high-pressure coupler fitting shown in FIG. 1A, sealingly engaged with connector fittings selected for sealing demountable engagement with an ultra-high-pressure fluid line;

FIG. 7 is a side view of the high-pressure connector assembly from FIG. 6, shown sealingly engaged in an offset alignment;

FIG. 8 shows orthogonal views of the separated female component (FIG. 8A) and male component (FIG. 8B) comprising the high-pressure connector assembly shown in FIGS. 6, 7;

FIG. 9 shows side views of the separated female component (FIG. 9A) and male component (FIG. 9B) comprising the high-pressure connector assembly;

FIG. 10 is an exploded cross-sectional side view of the inline-aligned high-pressure connector assembly shown in FIG. 6;

FIG. 11 is an exploded cross-sectional side view of the offset-aligned high-pressure connector assembly shown in FIG. 6;

FIG. 12 shows an orthogonal view of another example of an embodiment of a two-piece offset high-pressure coupling fitting according to the present disclosure (FIG. 12A) and a side view of the coupling fitting (FIG. 12B);

FIG. 13 is a cross-sectional side view of the two-piece offset high-pressure coupling fitting shown in FIG. 12;

FIG. 14 is a cross-sectional side view of a flow of highly pressurized fluid through the two-piece offset high-pressure coupling fitting shown in FIG. 12;

FIG. 15 shows an orthogonal view of another example of an embodiment of a two-piece offset high-pressure coupling fitting according to the present disclosure (FIG. 15A) and a side view of the coupling fitting (FIG. 15B);

FIG. 16 is a cross-sectional side view of the two-piece offset high-pressure coupling fitting shown in FIG. 15;

FIG. 17 is an orthogonal view of another example of an embodiment of an offset high-pressure coupling fitting comprising a female body component and a pair of matching male body components;

FIG. 18 is a cross-sectional side view of the offset high-pressure coupling fitting shown in FIG. 17; and

FIG. 19 is a cross-sectional side view of a flow of highly pressurized fluid through the offset high-pressure coupling fitting shown in FIG. 18.

### DETAILED DESCRIPTION

As used herein, the term “about” refers to an approximate +/−10% variation from a given value. It is to be understood that such a variation is always included in any given value provided herein, whether or not it is specifically referred to.

As used herein, the term “lines” refers to piping, tubing, conduits, nipples, and the like that are commonly incorporated into piping infrastructures configured for conveying therein and therethrough selected fluids under pressure.

As used herein, the term “medium pressure” refers to fluids conveyed with a pressurized piping infrastructure, that have been pressurized to about 22,500 psi (1,550 bar; 155 mPa).

As used herein, the term “high pressure” refers to fluids conveyed with a pressurized piping infrastructure, that have been pressurized to about 65,500 psi (4,480 bar; 448 mPa).

As used herein, the term “ultra-high pressure” refers to fluids conveyed with a pressurized piping infrastructure, that have been pressurized to about 152,000 psi (10,500 bar; 1,048 mPa).

The embodiments of the present disclosure pertain to offset-alignment pivotable high-pressure coupler fittings for sealing interconnection and engagement with two misaligned lines, selected for conveying therein pressurized fluids, within a pressurized piping infrastructure that interconnects a plurality of industrial equipment. Those skilled in these arts will understand that the offset-alignment pivotable high-pressure coupler fittings configured for conveyance therethrough of fluids pressurized up to 65,500 psi may be made of carbon steel or stainless steel whereas coupler fittings configured for conveyance therethrough of ultra-high-pressurized fluids (i.e. up to 152,000 psi) may be made of stainless steel.

According to an example of an embodiment of the present disclosure, one of the two-part offset-alignment coupler fittings is a male part and comprises a body having a bore therethrough, the body having a receptacle at one end wherein the receptacle is configured for sealing communication with a first pressurized fluid line, and the opposite end has a collar and a symmetrical convex bowl-shaped protrusion extending outward therefrom the collar. The other of the two-part offset-alignment coupler fittings is a female part and comprises a body having a bore therethrough having a receptacle at one end, wherein the receptacle is configured for sealing communication with a second pressurized fluid line, and the opposite end has a collar and a symmetrical concave bowl-shaped recess extending inward therefrom the collar. The curvilinear structure of the surface of the symmetrical convex bowl-shaped protrusion extending outward therefrom the collar of the male part matches the curvilinear structure of the surface of the symmetrical concave bowl-shaped recess extending inward therefrom the collar of the female part whereby the convex surface of the male part and the concave surface of the female part are slidingly communicable and engageable. The male part and the female part of the two-part offset-alignment coupler fittings disclosed herein may be demountable and sealingly engaged by threaded means. According to one aspect, the curvilinear structures of the symmetrical convex bowl-shaped protrusion and the matching symmetrical concave bowl-shaped recess, may be matching shallow bowl shapes wherein the depth of the shallow concave bowl-shaped recess and the height of the shallow convex bowl-shaped protrusion are 1 mm or 2 mm or 3 mm or 4 mm or 5 mm. According to another aspect, the curvilinear structures of the symmetrical convex bowl-shaped protrusion and the matching symmetrical concave bowl-shaped recess, may be matching deep bowl shapes wherein the depth of the deep concave bowl-shaped recess and the height of the deep convex bowl-shaped protrusion are selected from a range of about 6 mm to about 15 mm and therebetween.

An example of a two-part offset-alignment pivotable high-pressure coupler fitting 5 disclosed herein, wherein the male part 20 and the female part 10 have shallow symmetrical bowl-shaped curvilinear structures defining their convex protrusion 26 and concave recess 16, is illustrated in FIGS. 1-5. The female part 10 FIGS. 2A, 4A, 5A, has a hexagonal body 12 with a collar 14 at one end, and a bore 18 therethrough. The collar 14 of the female part 10 has a shallow symmetrical concave bowl-shaped recess 16 extending inward therefrom. The collar 14, as illustrated in FIGS. 2A, 4A, 5A, has six equidistantly spaced-apart threaded bores 15 therearound and therethrough. Alternatively, the collar 14 may have three or four or five or seven or more equidistantly spaced-apart threaded bores therearound and therethrough. The female hexagonal body portion 12 is suitably sized for demountable gripping engagement with a wrench. The male part 20 FIGS. 2B, 3B, 4B, 5B, has a threaded body portion 22 with a collar 24 at one end, and a bore 28 therethrough. The collar 24 of the male part 20 has a shallow symmetrical convex bowl-shaped protrusion extending outward therefrom and is configured to slidingly engage and pivot about therein the shallow symmetrical concave bowl-shaped recess 16 in the female part 10. The collar 24, as illustrated in FIGS. 2B, 4B, 5B, has six equidistantly spaced-apart two-stage bores 25 therearound and therethrough. Alternatively, the collar 24 may have three or four or five or seven or more equidistantly spaced-apart two-stage bores therearound and therethrough that are aligned with the spaced-apart threaded bores provided therethrough the collar 14. Each of the six equidistantly spaced-apart two-stage bores 25 is configured for receiving therethrough a bolt 27 and retaining therein the head of the bolt 27. The two-part offset-alignment coupler fitting 5 can be used to sealingly engaged to misaligned UHP lines by first sealably interconnecting one line to the female part 10 and the other line to the male part 20, using one or more suitable high pressure or UHP fitting components known to those skilled in this art for example gland nuts, collars, collets, and collet bodies. Then, the female part 10 and the male part 20 of the coupler fitting can then be engaged by inserting a bolt 27 through each of the spaced apart two-stage bores in the male collar 24 and then threadingly engaging a corresponding threaded bore 15 in the female collar 14, and then appropriately tightening each of the bolts 27 until sealing engagement of the two misaligned lines is achieved as shown in FIG. 1A. It should be noted that the two-part offset-alignment coupler fitting 5 can also be used to sealingly engage two high-pressure lines or UHP lines that are in alignment. It should also be noted that it is within the scope of the present disclosure for the female part of the two-part offset-alignment coupler fitting to be provided with a threaded body portion, and for the male part to be provided with a hexagonal body portion.

Another example of a two-part offset-alignment pivotable high-pressure coupler fitting 105 according to the present disclosure is illustrated in FIGS. 6-11. The female part 110 and the male part 120 have deep symmetrical bowl-shaped curvilinear structures defining their concave recess 116 and their concave protrusion 126 as shown in FIGS. 8A, 8B, 10, 11. In this example, the female part 110 comprises a hexagonal-shaped body portion 112 with a collar portion 114 at one end, with a bore 118 extending therethrough the female part 110. The inner surface of the hexagonal-shaped body portion 112 defining the bore 118, is provided with a female-threaded portion extending thereinto. The collar 114 of the female part 10 has a deep symmetrical concave bowl-shaped recess 116 extending inward therefrom. The collar 114, as illustrated in FIG. 8A, has six equidistantly spaced-apart threaded bores 115 therearound and therethrough. The female hexagonal body portion 112 is suitably sized for demountable gripping engagement with a wrench.

The male part 120 (FIGS. 6, 7, 8B, 9B, 10, 11) has a threaded body portion 122 with a collar 124 at one end, and a bore 218 therethrough. The collar 124 of the male part 120 has a deep symmetrical convex bowl-shaped protrusion 126 extending outward therefrom, and is configured to slidingly engage and pivot about therein the deep symmetrical concave bowl-shaped recess 116 in the female part 110. The male collar 124, as illustrated in FIG. 8B, has six equidistantly spaced-apart two-stage bores 215 therearound and therethrough. Alternatively, the collar 124 may have three or four or five or seven or more equidistantly spaced-apart two-stage bores therearound and therethrough that are aligned with the spaced-apart threaded bores provided therethrough the female collar 114. Each of the six equidistantly spaced-apart two-stage bores 125 is configured for receiving therethrough a bolt 127 and retaining therein the head of the bolt 127. The two-part offset-alignment coupler fitting 105 can be used to sealingly engage two misaligned UHP lines by first sealably interconnecting one line to the female part 110 and the other line to the male part 120, using one or more suitable high-pressure or UHP fitting components known to those skilled in this art for example gland nuts 130, threaded nipples 140, collars, collets, and collet bodies 150 as shown in FIGS. 6-11. Then, the female part 110 and the male part 120 of the coupler fitting 105 can then be engaged by inserting a bolta 27 through each of the spaced apart two-stage bores 125 in the male collar 124 and then threadingly engaging a corresponding threaded bore 115 in the female collar 114, and then appropriately tightening each of the bolts 127 until sealing engagement of the two misaligned lines is achieved as shown in FIGS. 7, 11. It should be noted that the two-part offset-alignment coupler fitting 105 can also be used to sealingly engage two high-pressure lines or UHP lines that are in alignment, as shown in FIGS. 6, 10.

An example of a three-part offset-alignment pivotable high-pressure coupler fitting 200 according to another embodiment of the present disclosure is illustrated in FIGS. 12-14, and comprises a female part 210, a male part 220, and a collar 230. The female part 210 comprises a female body 211 with a bore 204 therethrough an inlet end 213. The outlet end of the female body 211 houses a substantially spherical cavity 219 that is in fluid communication with the bore 204 (FIGS. 13, 14). The female body 211 has a collar portion 214 and a hexagonal portion 212. The hexagonal body portion 212 is suitably sized for demountable gripping engagement with a wrench FIGS. 12B, 13). The collar portion 214, in this example, is provided with four equidistantly spaced-apart two-stage bores 215, each configured for receiving therethrough a bolt 235 and retaining therein the head of the bolt 235 (FIG. 12A). The male part 220 comprises a male body 221 having a spherical-shaped inlet end 222 and an outlet end 224 (FIG. 13) configured for sealing demountable engagement with another selected suitable high-pressure or UHP fitting component known to those skilled in this art for example a gland nut or a collar or the like (not shown). The spherical-shaped inlet end 222 of the male part 220 is configured to slidingly engage and pivot about therein the substantially spherical cavity 219 in the female part 210. The male body 221 has a bore 226 therethrough the outlet end which is flared out in the spherical-shaped inlet end 222 to form a funnel-shaped cavity 228. The collar 230 is provided with four threaded bores 232 therethrough (FIGS. 12A, 13) that are alignable with the four equidistantly spaced-apart two-stage bores 215 provided in the collar portion 214 of the female component 210.

The three-part offset-alignment pivotable high-pressure coupler fitting 200 may be used to sealingly interconnect two misaligned high-pressure lines or UHP lines by: (i) mounting and sealingly engaging a female component 210 onto the end of one of the misaligned high-pressure lines or UHP lines, (ii) slipping the collar 230 and a compressible O-ring 240 over the end of the other of the misaligned high-pressure lines or UHP lines and then (iii) mounting and sealingly engaging a male component 220 onto the end of the other of the misaligned high-pressure lines or UHP lines, after which, (iv) the spherical-shaped inlet end 222 of the male part 220 is then inserted into the spherical cavity 219 of the female part 210, after which, (v) the O-ring 240 is snugged around the spherical-shaped inlet end 222 of the male part 220 against the outer rim of female body 211, and (vi) a bolt 235 is slipped through each of the two-stage bores 215 on the female collar 214, and threadingly engaged with its corresponding threaded bore 232 until the O-ring 240 is sealingly compressed between the female component 210 and the male component 220 (FIG. 13). Those skilled in this art will understand that suitable O-rings 240 to provide leak-proof compression between the female part 210, the male part 220, and the collar 230 are those that are commonly available for high-pressure coupling fittings and for UHP coupling fittings and comprise materials such as nitrile-butadiene (NBR) or fluorocarbon (FKM, FPM) or zinc-plated steel or zinc-nickel alloys or stainless steel and the like. It is to be noted that the angle of the flared funnel-shaped cavity 228 provided in the male body 221 of the male part 220 can be adjusted to deflect a flow of pressurized fluid from the female part 210 into and through the male part 220 by about 30° (FIG. 14) or less, for example 25°, 20°, 15°, 10°, 5°, 3° , 1°, and therebetween.

An example of a four-part offset-alignment pivotable high-pressure coupler fitting 300 according to another embodiment of the present disclosure is illustrated in FIGS. 15-16, and comprises a female part 310, a male part 320, a first gland nut 360, and a second gland nut 365. The female part 310 comprises a female body 311 with a bore 304 therethrough an inlet end 313. The outlet end of the female body 311 houses a substantially spherical cavity 319 that is in fluid communication with the bore 304 (FIG. 16). The female body 311 has a collar portion 314 and a hexagonal portion 312. The hexagonal body portion 312 is suitably sized for demountable gripping engagement with a wrench FIGS. 15B, 16). The collar portion 314, in this example, is provided with a first male-threaded section 315 therealong from the inlet end and a second male-threaded section 317 therealong from the outlet end (FIG. 16). The male part 320 comprises a male body 321 having a spherical-shaped inlet end 322 and an outlet end 324 (FIG. 16) configured for sealing demountable engagement with another selected suitable high-pressure or UHP fitting component known to those skilled in this art for example a gland nut or a collar or the like (not shown). The spherical-shaped inlet end 322 of the male part 320 is configured to slidingly engage and pivot about therein the substantially spherical cavity 319 in the female part 310. The male body 321 has a bore 326 therethrough the outlet end which is flared out in the spherical-shaped inlet end 322 to form a funnel-shaped cavity 328. The first gland nut 360 is provided with an inward facing female thread that is threadably engageable with the first male-threaded section 315 of the collar portion 314 of the female part 310 (FIG. 16). The second gland nut 365 is provided with an inward-facing female thread that is threadably engageable with the second male-threaded section 317 of the collar portion 314 of the female part 310 (FIG. 16).

The four-part offset-alignment pivotable high-pressure coupler fitting 300 may be used to sealingly interconnect two misaligned high-pressure lines or UHP lines by: (i) mounting and sealingly engaging a female component 310 onto the end of one of the misaligned high-pressure lines or UHP lines, (ii) threadably engaging the first gland nut 360 with the first male-threaded section 315 of the collar portion 314 of the female part 310, (iii) slipping the second gland nut 365 and a compressible O-ring 340 over the end of the other of the misaligned high-pressure lines or UHP lines and then (iii) mounting and sealingly engaging a male component 320 onto the end of the other of the misaligned high-pressure lines or UHP lines, after which, (iv) the spherical-shaped inlet end 322 of the male part 320 is then inserted into the spherical cavity 319 of the female part 310, after which, (v) the O-ring 340 is snugged around the spherical-shaped inlet end 322 of the male part 320 against the outer rim of female body 311, and (vi) the second gland nut 365 is threadingly engaged with the second male-threaded section 317 of the collar portion 314 of the female part 310 until the O-ring 340 is sealingly compressed between the female component 310 and the male component 320 (FIG. 13). Those skilled in this art will understand that suitable O-rings 340 to provide leak-proof compression between the female part 310, the male part 320, and the second gland nut 365 are those that are commonly available for high-pressure coupling fittings and for UHP coupling fittings and comprise materials such as nitrile-butadiene (NBR) or fluorocarbon (FKM, FPM) or zinc-plated steel or zinc-nickel alloys or stainless steel and the like. It is to be noted that the angle of the flared funnel-shaped cavity 328 provided in the male body 321 of the male part 320 can be adjusted to deflect a flow of pressurized fluid from the female part 310 into and through the male part 320 by about 30° (FIG. 16) or less, for example 25°, 20°, 15°, 10°, 5°, 3°, 1°, and therebetween.

An example of a five-part offset-alignment pivotable high-pressure coupler fitting 400 according to another embodiment of the present disclosure, is illustrated in FIGS. 17-19, and comprises a female part 470, two identical male parts 420a, 420b, a first compression collar 480, and a second compression collar 490. The female part 470 comprises a cylindrical body having a pair of matched substantially spherical cavities 472a, 472b extending thereinto from the ends of the cylindrical body (FIG. 18). The female body 470 has a collar portion 478 extending outward therefrom around the circumference of its cylindrical body wherein the collar portion 478 is situated at the midpoint between its two ends (FIG. 18). The collar portion 478, in this example, is provided with four equidistantly spaced-apart bores therethrough wherein each bore is configured to receive therethrough a bolt 495 (FIG. 18). Each of the two male parts 420a, 420b comprise a male body having a spherical-shaped end 422a, 422b and an end 424a, 424b (FIG. 18) configured for sealing demountable engagement with another selected suitable high-pressure or UHP fitting component known to those skilled in this art for example a gland nut or a collar or the like (not shown). Each of the male parts 420a, 420b have a bore 426a, 426b therethrough their ends 424a, 424b which are flared out in their spherical-shaped inlet ends 422a, 422b to form funnel-shaped cavities 428a, 428b (FIG. 18). The first compression collar 480 is provided with four equidistantly spaced-apart two-stage bores 482 (FIG. 18) that are aligned with the four equidistantly spaced-apart bores in the female collar portion 478 (FIG. 18). The second compression collar 490 is provided with four threaded bores 492 therethrough (FIGS. 17, 18) that are alignable with the four equidistantly spaced-apart bores in the female collar portion 478 and the four equidistantly spaced-apart two-stage bores 482 in the first compression collar 480 (FIG. 18). Each of the four threaded bores 492 in the second compression collar 490 is configured for threadable engagement with a bolt 495 (FIG. 18).

The five-part offset-alignment pivotable high-pressure coupler fitting 400 may be used to sealingly interconnect two misaligned high-pressure lines or UHP lines by: (i) slipping a first compression collar 480 and a suitable O-ring 440a over the end of one of the misaligned high-pressure lines or UHP lines and then mounting and sealingly engaging a first male part 420a onto the end of one of the misaligned high-pressure lines or UHP lines, (ii) slipping a second compression collar 490 and a suitable O-ring 440b over the end of the other of the misaligned high-pressure lines or UHP lines and then mounting and sealingly engaging a second male part 420b onto the end of the other of the misaligned high-pressure lines or UHP lines, (iii) inserting the first male part 420a into a spherical cavity 472a of a female part 470, (iv) inserting the second male part 420b into the other spherical cavity 472b of the female part 470, (v) snugging O-rings 440a, 440b against the outer-facing edges of the female body part and the first and second compression collars 480, 490 respectively, (vi) aligning the two-stage bores 482 in the first compression collar 480 with the bores in the collar portion 478 of the female body 470 and with the threaded bores 492 in the second compression collar, (vii) inserting a bolt 495 into each of the aligned bores in the first compression collar 480, the female body collar 478, and the second compression collar 490, and (viii) threadably engaging each bolt 495 with its threaded bore 492 until the O-rings 440a, 440b are sealingly compressed between the female body 470, the first compression collar, 480, and the second compression collar 490 (FIG. 18).

Those skilled in this art will understand that suitable O-rings 440a, 440b to provide leak-proof compression between the female part 470, the male parts 420a, 420b, and the first compression collar 480 and second compression collar 490 are those that are commonly available for high-pressure coupling fittings and for UHP coupling fittings and comprise materials such as nitrile-butadiene (NBR) or fluorocarbon (FKM, FPM) or zinc-plated steel or zinc-nickel alloys or stainless steel and the like. It is to be noted that this five-part offset-alignment pivotable high-pressure coupler fitting 400 may be used to sealingly interconnect two misaligned high-pressure lines in which the flow of pressurized fluid 500a, 500b is deflected by 60°, i.e., by 30° in each of the two male parts 420a, 420b (FIG. 19). It is to be noted that the extent of the fluid flow detection causes a minimum disruption 500c in the laminar flow of the pressurized fluid 500a, 500b. It is to be noted that the angle of the flared funnel-shaped cavities 228 provided in the male body 221 of the male part 220 can be adjusted to deflect a flow of pressurized fluid from the female part 210 into and through the male part 220 by about 30° (FIG. 16) or less, for example 25°, 20°, 15° , 10°, 5°, 3°, 1°, and therebetween.

Those skilled in this art will understand that it is optional to provide a first male-threaded portion on the cylindrical body of the female part extending from one end of the body to the collar portion extending outward therefrom the body at the midpoint between its two ends, and a second male-threaded portion on the cylindrical body of the female part extending from the other end of the body to its collar portion (not shown). A first gland nut configured for threadable engaging the first threaded portion on the cylindrical body of the female part, may be substituted for the first compression collar. A second gland nut configured for threadable engaging the second threaded portion on the cylindrical body of the female part, may be substituted for the second compression collar.

1. An offset-alignment pivotable high-pressure coupler fitting for use to demountably and sealingly engage two misaligned high-pressure fluid lines, the coupler fitting comprising:
a female part having a first female end configured for sealing demountable engagement with an end of a first high-pressure fluid line, a second female end having a female collar with a symmetrical spherical recess therein and at least three equidistantly spaced-apart bores therearound and therethrough, and a bore therethrough the female part from the first female end to the second female end for receiving a flow of pressurized fluid therethrough;
a male part having a first male end configured for sealing demountable engagement with an end of a first high-pressure fluid line, a second male end with a male collar with a symmetrical spherical protrusion arising therefrom, said symmetrical spherical protrusion matching the symmetrical spherical recess and slidingly communicable therewith, and wherein the male collar has at least three equidistantly spaced-apart bores therearound and therethrough in alignment with the at least three equidistantly spaced-apart bores in the female collar, and a bore therethrough the male part from the first male end to the second male end for receiving a flow of pressurized fluid therethrough; and
at least three demountable engagement means configured for communication and cooperation with the at least three equidistantly spaced-apart bores in the female part and with the at least three equidistantly spaced-apart bores in the male part.

2. An offset-alignment pivotable high-pressure coupler fitting according to claim 1, wherein the at least three demountable engagement means are threaded bolts and the one of the at least three equidistantly spaced-apart bores in the female collar and the male collar is provided with female threads therethrough for threadable demountable engagement with the threaded bolts and the other of the at least three equidistantly spaced-apart bores in the female collar and the male collar is configured to receive the threaded bolts therethrough.

3. An offset-alignment pivotable high-pressure coupler fitting according to claim 1, wherein a depth of the symmetrical spherical recess therein the female collar and the height of the symmetrical spherical protrusion extending therefrom the male collar are selected from a range of 1 mm to 5 mm.

4. An offset-alignment pivotable high-pressure coupler fitting according to claim 1, wherein a depth of the symmetrical spherical recess therein the female collar and the height of the symmetrical spherical protrusion extending therefrom the male collar are selected from a range of 5 mm to 15 mm.

5. An offset-alignment pivotable high-pressure coupler fitting according to any one of claims 1 to 4, wherein a portion of the female part has a hexagonal body configured for demountable engagement with a wrench.

6. An offset-alignment pivotable high-pressure coupler fitting according to any one of claims 1 to 5, wherein a portion of the male part has a hexagonal body configured for demountable engagement with a wrench.

7. An offset-alignment pivotable high-pressure coupler fitting according to any one of claims 1 to 5, wherein the first female end of the female part is provided with an internal female thread extending thereinto.

8. An offset-alignment pivotable high-pressure coupler fitting according to any one of claims 1 to 5, wherein the first male end of the male part is provided with an external male thread extending therealong.

9. An offset-alignment pivotable high-pressure coupler fitting according to claim 1, wherein the female collar of the female part comprises a substantially spherical cavity and the second male end of the male part comprises a substantially spherical shape without a collar whereby the second male end matches the substantially spherical cavity and is slidingly communicable therewith, said coupler fitting additionally comprising a retaining collar configured to retain therein the second male end of the male part and having at least at least three equidistantly spaced-apart threaded bores therearound and therethrough, said at least three equidistantly spaced-apart threaded bores in alignment with the at least three equidistantly spaced-apart bores in the female collar.

10. An offset-alignment pivotable high-pressure coupler fitting according to claim 9, wherein the female collar of the female part is provided with a first male-threaded portion therealong from the first female end and a second male-threaded portion therealong from the second female end,
said coupler fitting additionally comprising a first gland nut configured for threadable engagement with the first male-threaded portion there along the female collar, and a second gland nut configured for threadable engagement with the second male-threaded portion there along the female collar.

11. An offset-alignment pivotable high-pressure coupler fitting according to claim 9 or 10, additionally comprising an O-ring that is compressible between the female body and the retaining collar or between the female body and the gland nut.

12. An offset-alignment pivotable high-pressure coupler fitting according to any one of claims 1 to 11, wherein the two misaligned high-pressure fluid lines are ultra-high-pressure fluid lines.

13. An offset-alignment pivotable high-pressure coupler fitting for use to demountably and sealingly engage two misaligned high-pressure fluid lines, the coupler fitting comprising:
a female part having a cylindrical body with two ends and with a substantially spherical cavity facing outward at each end wherein the substantially spherical cavities are matching and are connected by a bore, said cylindrical body having a collar portion extending outward from the body at a midpoint between the two ends, said collar having at least three equidistantly spaced-apart bores therearound and therethrough;
a pair of male parts wherein each of the pair has a first male end configured for sealing demountable engagement with an end of a first high-pressure fluid line or a fitting therefor and a second male end that comprises a substantially spherical shape that matches the matching substantially spherical cavities in the female part, said second male end slidingly communicable therewith the spherical cavities in the female part;
a first retaining collar configured to retain therein the second male end of each male part, said first collar having at least at least three equidistantly bores therearound and therethrough, said at least three equidistantly spaced-apart threaded bores in alignment with the at least three equidistantly spaced-apart bores in the female collar wherein each of the threaded bores is a two-stage bore configured to retain a head of a threaded bolt therein; and
a second retaining collar configured to retain therein the second male end of each male part, said second collar having at least at least three equidistantly spaced-apart threaded bores therearound and therethrough, said at least three equidistantly spaced-apart threaded bores in alignment with the at least three equidistantly spaced-apart bores in the female collar wherein each of the threaded bores is threadably engageable with the threaded bolt.

14. An offset-alignment pivotable high-pressure coupler fitting according to claim 13, wherein the cylindrical body of the female part is provided with a first male-threaded portion therealong from one end to the collar and a second male-threaded portion therealong from the other end to the collar,
said coupler fitting additionally comprising a first gland nut configured for threadable engagement with the first male-threaded portion there along the cylindrical body of the female part, and a second gland nut configured for threadable engagement with the second male-threaded portion therealong the cylindrical body of the female part.

15. An offset-alignment pivotable high-pressure coupler fitting according to claim 13 or 14, additionally comprising a pair of O-rings wherein each of the pair of O-rings is compressible between the ends of the female body and first or second retaining collars or between the ends of the female body and the first of second gland nuts.

16. An offset-alignment pivotable high-pressure coupler fitting according to any one of claims 13 to 15, wherein the two misaligned high-pressure fluid lines are ultra-high-pressure fluid lines.
